(19) United States
(12) Patent Application Publication
(10) Pub. No.: US 2026/0084130 A1
(43) Pub. Date: Mar. 26, 2026

(54) REACTOR FOR THERMAL CRACKING OF A GASEOUS, HYDROCARBONACEOUS FEEDSTOCK STREAM

(71) Applicants: thyssenkrupp Uhde GmbH, Dortmund (DE); thyssenkrupp AG, Essen (DE)

(72) Inventors: Nicolai ANTWEILER, Essen (DE); Guido KACHE, Wiesbaden (DE)

(73) Assignees: thyssenkrupp Uhde GmbH, Dortmund (DE); thyssenkrupp AG, Essen (DE)

(21) Appl. No.: 19/110,172

(22) PCT Filed: Sep. 6, 2023
(86) PCT No.: PCT/EP2023/074385

§ 371 Date: Mar. 10, 2025

(30) Foreign Application Priority Data
Sep. 14, 2022 (DE) 10 2022 209 645.2

(51) Int. Cl. B01J 8/42; B01J 8/00; B01J 8/40; C10G 9/24; C10G 15/08

(52) U.S. Cl. CPC B01J 8/42; B01J 8/002; B01J 8/003; B01J 8/40; C10G 9/24; C10G 15/08; B01J 2208/00398; B01J 2208/00752

(57) ABSTRACT

A reactor for the thermal decomposition of a gaseous hydrocarbonaceous feedstock stream in an electrically heated moving bed composed of an electrically conductive granular material with deposition of elemental carbon on the granular material comprises an upper reactor section in which there are disposed a feed for the granular material and an outlet for a hydrogenous product stream, a middle reactor section, and a lower reactor section in which there is disposed a feeding device for the gaseous hydrocarbonaceous feedstock stream, and on the bottom side there is provided an outlet for the granular material, wherein the outlet comprises at least one funnel-shaped oscillating base that can be set in oscillation in vertical and/or horizontal direction by means of at least one first vibration generator and is connected to the lower reactor section via an oscillation-decoupling suspension.

### PRIOR ART

The invention relates to a reactor for the thermal decomposition of a gaseous hydrocarbonaceous feedstock stream according to the preamble of claim 1.

The pyrolysis of gaseous hydrocarbonaceous feedstock streams, especially natural gas or methane, constitutes an economically and ecologically advantageous mode of hydrogen production. The majority of industrially produced and consumed hydrogen has been produced to date via steam reforming of natural gas, in which large amounts of the greenhouse gas CO2 are released (called “gray” hydrogen). In the transition toward a climatically benign hydrogen economy, alternative manufacturing processes are required, in which the amount of CO2 released is reduced or even avoided entirely. This can be done firstly by separation and storage of the CO2 (also called “blue” hydrogen) formed in the conventional steam reforming process, or else by electrolysis of water using renewable power (“green” hydrogen).

The pyrolysis of natural gas or methane has advantages over these two alternatives. In pyrolysis, the hydrocarbons are directly separated into their constituents, elemental carbon and hydrogen. If the necessary energy supply for performance of this endothermic reaction is implemented using renewable energies, the process is CO₂-neutral. Compared to “blue” hydrogen, the advantage is thus that the complexity involved in the deposition and the complexity including possible risks of underground CO₂ storage are avoided. The resulting elemental carbon, on the other hand, can be partly reused as a product of value in a climate-neutral manner or landfilled easily.

Compared to the electrolysis of water, the advantage is a significant reduction in energy expenditure per tonne of hydrogen produced, since water has a distinctly higher binding energy per hydrogen atom present:

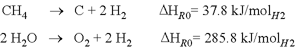

Under ideal conditions, for the production of hydrogen by pyrolysis, it is thus necessary to expend only about 13% of the energy required in the case of production by water electrolysis.

For these reasons, the pyrolysis of carbonaceous feedstock streams appears to be a pioneering technology for energy-efficient production of hydrogen.

Different methods are already known for the pyrolysis of hydrocarbonaceous feedstock streams. On the one hand, pyrolysis can be effected by electron beam plasma pyrolysis, in which the hydrocarbon molecules are dissociated by means of the kinetic energy of accelerated electrons. An apparatus for performing such a plasma analysis is known, for example, from DE 10 2020 116 950 A1. In addition, the feedstock stream can be introduced into a liquid metal bath in which the pyrolysis is effected. The resulting carbon then remains in the metal bath and has to be extracted subsequently. Such an apparatus is known from EP 3 521 241 A1.

A further alternative process is the purely thermal decomposition of gaseous hydrocarbonaceous feedstock streams in an electrically heated moving bed made of electrically conductive granular material. In a columnar reactor, the moving bed is guided from top to bottom under the effect of gravity. The hydrocarbonaceous feedstock stream flows in countercurrent from the bottom upward through the reactor. The moving bed is directly electrically heated in that at least two electrodes that are disposed in the moving bed conduct an electrical current through the moving bed. Most of the heat is generated at the contact sites of the individual grains of the granular material by resistance heating. In the case of uniform current flow, a reaction volume is created between the electrodes in which a temperature sufficient for pyrolysis in the range of 1000° C.-1500° C. is attained. The feedstock stream is cleaved thermally, with removal of the gaseous hydrogen released in the upward direction and deposition of the elemental carbon on the granular material. Such reactors are known, for example, from WO 2019/145279 A1 and WO 2020/244803 A1.

The disadvantage of these reactors is that, because of the precipitation of the elemental carbon on the granular material, electrically conductive bridging between the granules can occur. The larger the size of the reactor, the greater the extent of this problem, since the granules then remain within the reaction volume for longer and experience greater deposition. Formation of bridges between the grains of the granular material leads to a drop in electrical resistance between the electrodes and hence also to a lower heating output of the reactor. A path with reduced electrical resistance is gradually formed between the electrodes, through which the electrical current preferentially flows. With progressive caking of the granules, the hydrogen yield decreases until the heating concept ultimately fails. In addition, the caked-together granules hinder the transport of the moving bed through the reactor.

One conceivable measure to reduce formation of bridges is accelerated guiding of the moving bed through the reactor. This can reduce the amount of carbon deposited on the granules and reduce the tendency to form bridges as a result. However, this has the disadvantage of elevated energy expenditure required for the heating of the faster-circulating moving bed to heat up the greater amount of granules entering the reaction volume per unit of time to the required temperature. In addition, energy losses are caused by the escape of the moving bed from the reactor at a higher temperature, and it may even be necessary to further cool the granular material outside the reactor.

### DISCLOSURE OF THE INVENTION

It is therefore an object of the invention to provide a reactor for the thermal decomposition of a gaseous hydrocarbonaceous feedstock stream in an electrically heated moving bed, in which the tendency to bridging between the granules of the moving bed is reduced with simultaneously energy-efficient operation.

This object is achieved by a reactor having the features of claim 1.

In this way, a reactor is provided for the thermal decomposition of a gaseous hydrocarbonaceous feedstock stream in an electrically heated moving bed composed of an electrically conductive granular material with deposition of elemental carbon on the granular material. The reactor comprises an upper, middle and lower reactor section. In the upper reactor section, there are disposed a feed for the granular material and an outlet for a hydrogenous product stream. In the lower reactor section, there is disposed a feeding device for the gaseous hydrocarbonaceous feedstock stream, and there is provided an outlet for the granular material on the bottom side. According to the invention, it is provided that the outlet comprises at least one funnel-shaped oscillating base that can be set in oscillation in vertical and/or horizontal direction by means of at least one first vibration generator and is connected to the lower reactor section via an oscillation-decoupling suspension.

Because of the oscillation-decoupling suspension on the lower reactor section, the funnel-shaped oscillating base is set up to perform an oscillation in relative motion relative to the lower reactor section. The oscillation is thus transmitted particularly efficiently to the granular material in the reactor that bears on the oscillating base. The oscillating granular material firstly has improved fluidity, which results in homogenization of the residence time of the granular material in the reactor. The oscillating base thus assists the formation of a plug flow in the reactor. Local granule accumulation in the reactor is avoided and the tendency to bridging between the granules is reduced as a result.

On the other hand, the oscillation transmitted to the granular material by collisions between adjacent granules causes the granules to rotate in place. Even if neighboring granules do not move relative to one other at times in the granule flow, the rotations of the granules caused by the oscillating base ensure a regular change in the contact points of neighboring grains. Since the carbon formed in the pyrolysis is deposited primarily at the resistance-heated contact points, a regular change in the contact points is particularly effective in order to avoid bridging.

The granular material used preferably contains grains of a carbonaceous material. Suitable examples are granules with grains of pure carbon or coke. It is alternatively conceivable to use granules of silicon carbide or boron carbide, for example.

Preferably at least two electrodes disposed in the middle reactor section for heating of the moving bed. The positioning of the electrodes in the reactor and the flow rate of the granular material, and also the flow rate of the feedstock stream, indirectly defines a reaction volume in the reactor in which the reaction conditions exist for the pyrolysis. The reaction volume is preferably at least partly disposed in the middle reactor section. Alternatively, the reaction volume may extend into the upper and/or lower reactor sections.

In some embodiments, the electrodes comprise an upper electrode and a lower electrode, each extending along a horizontal cross-sectional surface of the reactor. In this case, the electrodes introduce an electrical field into the moving bed in vertical direction parallel to the direction of movement of the granular material.

In other embodiments, the electrodes are disposed on mutually opposite side walls of the reactor. The lateral arrangement of the electrodes reduces the impairment of the movement of the moving bed by the electrodes. In addition, the electrodes do not form a barrier to the transmission of the oscillations of the oscillating base to the granular material. This embodiment is preferably used in combination with a reactor of rectangular or square cross section. In this way, a particularly homogeneous electric field can be generated in the moving bed transverse to its direction of motion.

Alternatively or in addition to the electrodes, at least one coil for inductive heating of the moving bed may be disposed on the outside of the middle reactor section. Inductive heating of the moving bed from the outside has the advantage of introducing heat into the granular material without the need to arrange heating elements within the reactor, on which carbon deposits can occur and which affect the granular material flow.

In preferred embodiments, in the lower reactor section there is disposed a lower displacement body which is secured by means of a brace to the oscillating base and can be set in oscillation together with the oscillating base. Through the use of a displacement body in the lower reactor section, the oscillations of the oscillating base can additionally be introduced at a position in the reactor that is closer to the reaction volume. Such an embodiment is advantageous particularly in the case of large-scale reactors in which the vertical distance between the oscillating base and the reaction volume causes considerable attenuation of the induced granular material movements. The displacement body secured to the oscillating base forms a second vibration source in the moving bed, which increases the volume of the fluidized fraction in the moving bed. The lower displacement body preferably extends over at least 50%, more preferably over at least 75%, of the cross-sectional area of the reactor, in order to introduce the vibration with maximum uniformity over the reactor cross section.

The lower displacement body is preferably disposed above the feeding device. Since the feeding device can form resistance with regard to the propagation of vibration oscillations in the moving bed, it is advantageous to introduce the vibrations by using a displacement body only above the feeding device in order to achieve minimum hindrance of propagation of the oscillations into the reaction volume in the middle reactor section.

The lower displacement body is preferably disposed completely within a preheating volume of the reactor defined by the feeding device and the lowermost point on the electrodes. In particular, it is preferable when the displacement body is disposed completely within the upper half of the preheating volume. The lower displacement body is thus preferably positioned close to the reaction volume, but without projecting into it. If the displacement body were to extend into the reaction volume, increasing deposition of the elemental carbon on the displacement body would be expected. This would hinder the flow of the granular material, and regular maintenance operations on the reactor would be required.

The displacement body may additionally have extensions projecting into cut-outs in a lower electrode. Such extensions can carry the vibration of the oscillating base into the space above the electrode. In addition, the oscillating electrodes can promote the flow of granular material through the cut-outs in the electrode.

In other preferred embodiments, the displacement body forms the lower electrode. This has the advantage that the oscillation is introduced into the moving bed as close as possible to the reaction volume and that the displacement body does not constitute an additional barrier in the granular material flow.

The displacement body preferably has a conical or frustoconical surface. Conical surfaces also cause the granular material to oscillate more intensely with a horizontal motion component that promotes relative movements between adjacent grains of the granular material. In addition, conical surfaces act as a baffle and ensure improved flow around the displacement body in the granular material flow. The cone angle of the surface is preferably in the range between 90° and 160°, more preferably between 120° and 152°.

The displacement body may preferably have apertures for the flow of the granular material, and these, in a vertical projection, account for between 10% and 60%, particularly preferably between 30% and 50%, of a total area of the displacement body For such an opening ratio of the displacement body, a preferred compromise is established between desired excitation of the granular material and excessively high flow hindrance in the granular material flow.

In individual embodiments of the invention, in addition to the oscillating base and alternatively or additionally to the lower displacement body in the upper reactor section, there may be disposed an upper displacement body that can be set into oscillation by means of at least one second vibration generator. The upper displacement body can induce improved oscillation in an upper portion of the moving bed.

The at least one vibration generator is preferably set up to generate oscillations of the oscillating base with a frequency in the range from 25 Hz to 75 Hz and/or an oscillation speed in the range from 10 mm/s to 40 mm/s.

Further advantageous embodiments can be inferred from the description that follows and the subsidiary claims.

The invention will be discussed in detail hereinafter with reference to the working examples shown in the appended figures.

### BRIEF DESCRIPTION OF THE DRAWINGS

FIG. 1 shows a schematic of a reactor according to a first working example of the invention with a displacement body and electrodes that extend in horizontal direction,

FIG. 2 shows a schematic of a reactor according to a second working example of the invention, where the displacement body forms the lower electrode,

FIG. 3 shows a schematic of a reactor according to a third working example of the invention with electrodes disposed on opposite side walls,

FIG. 4 shows a schematic of a reactor according to a fourth working example of the invention, in which the displacement body is disposed entirely within an upper half of the preheating volume,

FIG. 5A shows a schematic of a reactor according to a fifth working example of the invention with a lower and an upper displacement body, each having extensions that project into cut-outs of the assigned electrodes,

FIG. 5B shows a schematic of a cross section of the reactor according to FIG. 5A in a horizontal section plane at the height of the lower electrode,

FIG. 6A-6E shows schematics of various embodiments of displacement bodies with a conical or frustoconical surface,

FIG. 6F-6G shows schematics of the displacement bodies according to FIG. 6C to 6E in a vertical projection, and

FIG. 7 shows a schematic of a reactor according to a sixth working example of the invention with inductive heating of the moving bed.

### EMBODIMENTS OF THE INVENTION

In the various figures, identical parts are always denoted by the same reference signs, and will therefore generally also be named or mentioned only once in each case.

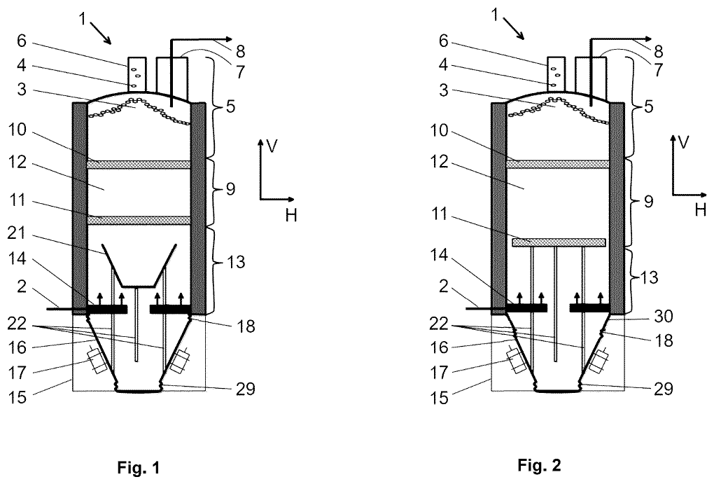

FIG. 1 shows a reactor 1 for the thermal decomposition of a gaseous hydrocarbonaceous feedstock stream 2 in an electrically heated moving bed 3 composed of an electrically conductive granular material 4 with deposition of elemental carbon on the granular material 4. The reactor 1 is preferably generally cylindrical and extends in a vertical direction V. The cross section of the cylinder may, for example, be circular, rectangular, square or polygonal. For performance of the thermal decomposition, the reactor 1 is designed for temperatures of the moving bed 3 in the range from 1000° C. to 1500° C. and gas pressures of up to 40 bar (g).

The reactor 1 comprises three sections arranged one on top of another, each providing different functions of the reactor 1: an upper reactor section 5, a middle reactor section 9 and a lower reactor section 13.

In the upper reactor section 5, there are disposed a feed 6 for the granular material 4 and an outlet 7 for a hydrogenous product stream 8. The granular material 4 is accordingly fed to the top side in operation of the reactor 1 and travels through the reactor 1 as a moving bed 3 in vertical direction V. In addition to the carbon being deposited on the granular material 4, there is generally also formation of further elemental carbon in the form of soot particles in operation of the reactor 1, some of which leave the reactor 1 in the downward direction with the moving bed 3 and some of which are discharged with the hydrogenous product stream 8.

In the middle reactor section 9, there are preferably disposed at least two electrodes 10, 11; 10′, 11′ for heating of the moving bed 3. The electrodes 10, 11; 10′, 11′ cause a reaction volume 12 within the reactor 1 during operation. The reaction volume 12 of the reactor 1 is defined as the space in which a sufficient temperature is attained in operation for the thermal decomposition of the hydrocarbonaceous feedstock stream. Since the electrodes cause electrical resistance heating of the moving bed 3 in operation, the reaction volume 12 is usually between and bounded by the electrodes 10, 11. The electrical current flows through the moving bed 3 in operation between the electrodes 10, 11; 10′, 11′ and is dissipated owing to the electrical resistance of the moving bed 3 to thermal energy. The electrical resistance results from the contact points between the granules or the small transfer areas, while the granules themselves preferably have comparatively high conductivity. As shown in FIG. 1, the electrodes 10, 11, for example, may comprise an upper electrode 10 and a lower electrode 11, each extending along a cross-sectional area in horizontal direction H of the reactor 1.

However, the position and extent of the reaction volume 12 is also determined by the flow of the granular material 4 and the flow of the feedstock stream 2 in the reactor 1, since the materials transport the resultant thermal energy onward in the reactor 1 by virtue of their inherent heat capacity. Through appropriate choice of the flow conditions in the reactor, the reaction volume can also extend outside the space bounded by the electrodes 10, 11; 10′, 11′.

In the lower reactor section 13, there is disposed a feeding device 14 for the gaseous hydrocarbonaceous feedstock stream 2. The gaseous feedstock stream 2 is directed upward in vertical direction V in countercurrent to the moving bed 3. In a preheating volume thus formed between the feeding device 14 and the lowermost point in the electrodes 10, 11, the feedstock stream 2 is preheated with the thermal energy of the moving bed 3 emerging from the reaction volume 12, but does not yet reach the temperature required for thermal pyrolysis.

The preheating volume forms a lower of two heat integration zones in the reactor 1. In the lower heat integration zone, thermal energy of the moving bed 3 exiting from the reaction volume is released, preferably as completely as possible, to the feedstock stream 2. The second, upper heat integration zone is formed in the upper reactor section 5, in which thermal energy from the gaseous product stream 8 is released, preferably as completely as possible, to the moving bed 3, before this enters the reaction volume 12 at the top. Because of the formation of two heat integration zones within the reactor 1, the thermal energy can be largely kept within the reactor 1, and the need for external heat exchangers is correspondingly reduced.

Furthermore, an outlet 15 for the granular material 4 is provided at the bottom end of the lower reactor section 13. According to the invention, the outlet 15 comprises at least one funnel-shaped oscillating base 16. The oscillating base 16 can be set in oscillation in vertical direction V and/or horizontal direction H by means of at least one first vibration generator 17. The vibration generator 17 is preferably designed to set the oscillating base 16 in a movement which is circular in horizontal direction H and vertical direction V. More preferably, the horizontal component of the movement of the oscillating base 16 is greater than the vertical component of the movement.

The outlet 15 may preferably have an enclosure on the outer face of the oscillating base 16 that faces away from the moving bed 3. The enclosure allows outside pressurization of the oscillating base 16 with a gas pressure from a pressure source. As a result, pressure loads on the oscillating base 16 can be reduced. The gas pressure preferably corresponds to the prevailing pressure in the reactor 1 with a tolerance of +/−50%, especially preferably +/−25%.

The oscillating base 16 is connected to the lower reactor section 13 via an oscillation-decoupling suspension 18, for example a free-swinging ring buffer suspension. In the downward direction, the oscillating base 16 preferably likewise connects in an oscillation-decoupled manner via an outlet sleeve 29 to a discharge device, usually a screw conveyor (not shown).

Vibration generators 17 used are preferably unbalanced motors, for example electric unbalanced oscillators. Alternatively or additionally, it is also possible to use other vibration generators, for example hydraulic or pneumatic agitators. The at least one vibration generator 17 may preferably be set up to generate oscillations of the oscillating base 16 with a frequency in the range from 25 Hz to 75 Hz and/or an oscillation speed in the range from 10 mm/s to 40 mm/s.

In operation of the reactor 1, the oscillating base 16 sets the granules of the moving bed 3 in a motion which preferably comprises not only translational components but also rotations of the granules. The movement results in conveying of the outflow of the granular material 4 through the outlet 15, so as preferably to form a uniform downward movement of the moving bed 3 in the manner of a plug flow in the reactor 1. In addition, the movement of the granules in the region of the reaction volume 12 leads to constantly changing contact points of the granules, which reduces the tendency to bridging through deposited carbon.

However, the movement of the granules introduced by the oscillating base 16 is attenuated by internals in the reactor 1, for example the feeding device 14 or a horizontally extending electrode 11, but also by the granular material 4 itself. Depending on the size of the extension of the lower reactor section 13 and the positioning of the internals mentioned, it may therefore be advantageous when a lower displacement body 21 is disposed in the lower reactor section 13 and is secured to the oscillating base 16 by means of a brace 22 and can be set in oscillation together with the oscillating base 16. The brace may, for example, consist of a central strut or multiple struts distributed over the circumference of the oscillating base 16. As shown in FIG. 1, the displacement body 21 is preferably disposed above the feeding device 14 and especially preferably disposed entirely within the preheating volume of the reactor between the feeding device 14 and the lowermost point on the electrode 10.

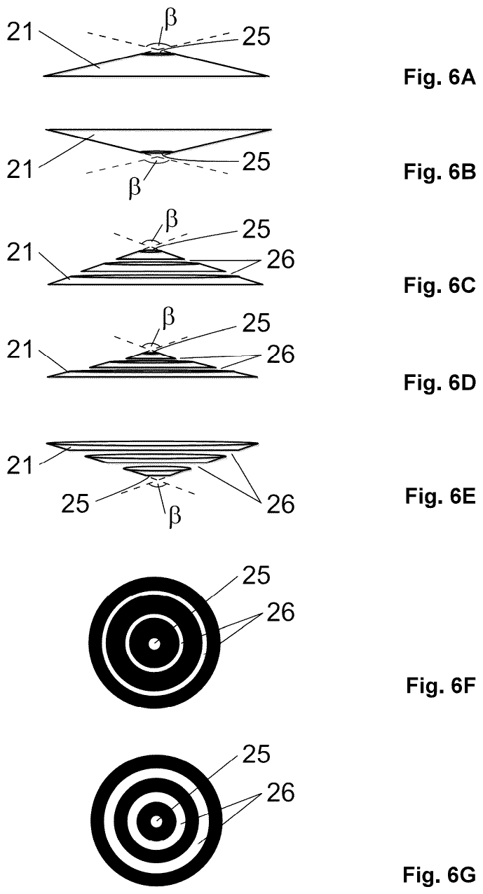

In the working example shown in FIG. 1, the displacement body 21 has a frustoconical surface that tapers downward. At least in the central region, the surface has an aperture to allow the granular material 4 to pass through. Further possible shapes of the displacement body are elucidated in detail with reference to FIG. 6.

FIG. 2 shows a second working example of an inventive reactor 1. The reactor 1 differs from the first working example according to FIG. 1 in that the displacement body 21 forms the lower electrode 11. This has the advantage that the lower electrode 11, rather than forming a barrier in the movement of the granules induced by the oscillating base 16, itself induces movement in the granular material 4. In this way, the granular material 4 can be set in motion particularly effectively within the reaction volume 12. If the displacement body 21 simultaneously forms the lower electrode 11, in the shaping of the displacement body 21/the electrode 11, it should additionally be taken into account that there is also homogeneous heating of the reaction volume over the cross-sectional area of the reactor 1. This criterion preferably leads to a flat, gridlike structure of the displacement body 21.

Another independent difference from the first working example is the positioning of the suspension 18. As can be seen from FIG. 2, the suspension 18 does not necessarily have to be disposed at the interface between the lower reactor section 13 and the outlet 15. For load-related reasons in particular, it may be advantageous to dispose the suspension 18 in the region of a funnel-shaped taper of the outlet 15, as shown in FIG. 2.

Otherwise, the statements relating to the first working example are correspondingly applicable to the second working example.

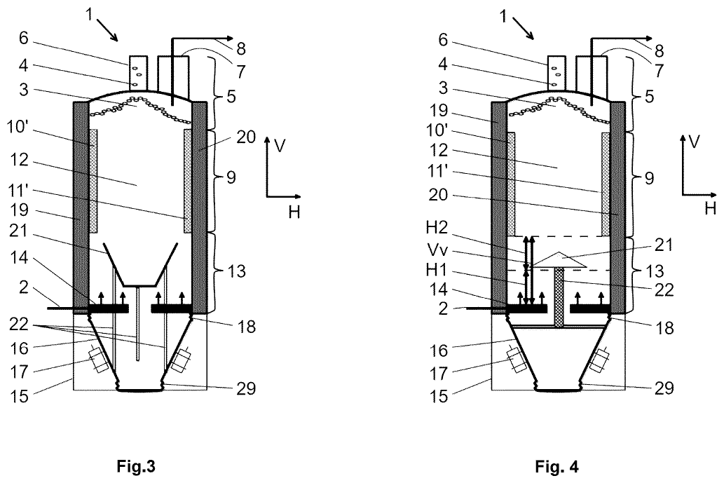

The third working example shown in FIG. 3 differs from the first working example in the arrangement of the electrodes 10′, 11′. In FIG. 3, the electrodes 10′, 11′ are disposed on mutually opposite side walls 19, 20 of the reactor. This arrangement of the electrodes 10′, 11′ is advantageous because the electrodes 10′, 11′, because of their lateral positioning, cause significantly lower attenuation of the movements introduced into the moving bed 3 by the oscillating base 16. In this way, the oscillations are transported more effectively into the reaction volume 12. In order to form a homogeneous electric field, this arrangement of electrodes 10′, 11′ is preferably used in combination with a reactor 1 of rectangular, square or polygonal cross section.

Otherwise, the statements relating to the first two working examples are correspondingly applicable to the third working example.

The fourth working example shown in FIG. 4 is a variant of the third working example having a displacement body having a conical surface. In this case, the displacement body 21 is not only disposed completely within the preheating volume Vv but is actually completely within the upper half H2 thereof, while the lower half H1 is penetrated only by the preferably vertical brace 22.

Moreover, the statements relating to the first three working examples are correspondingly applicable to the fourth working example.

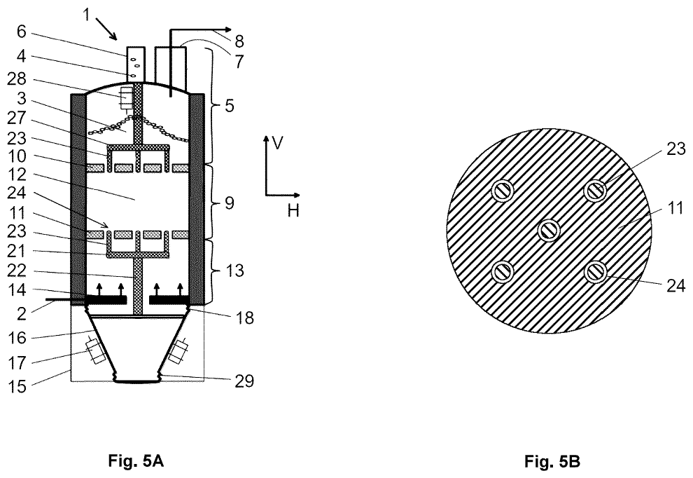

FIG. 5A shows a fifth working example of the invention, which differs from the first working example by the type and arrangement of the displacement body 21. According to FIG. 5A, the displacement body 21 is formed with extensions 23 which project into cut-outs 24 in the lower electrode 11. The arrangement of extensions 23 and cut-outs 24 of the lower electrode 11 is shown in cross section in FIG. 5B. In order to reliably ensure flow of granular material in the region of the cut-outs 24, the gap width between extension 23 and the edge of the cut-out 24 should correspond to at least 5 times the grain size of the granular material 4.

A further difference from the first working example is that, in the upper reactor section 5, there is disposed an upper displacement body 27 which can be set in oscillation by means of at least one second vibration generator 28. In the example shown, the shape and arrangement of the upper displacement body 27 corresponds to the lower displacement body 21. However, it is also possible in accordance with the invention to use any other forms and combination of lower and upper displacement body.

FIG. 6 shows various other forms of displacement bodies 21 usable in accordance with the invention. FIG. 6A shows an upward-tapering and FIG. 6B a downward-tapering displacement body 21 with a frustoconical surface and a central aperture 25. FIG. 6C and FIG. 6D show displacement bodies having conical surfaces, and having not only a central aperture 25 but also annual apertures 26. The annular apertures 26 are larger in the case of FIG. 6D. FIG. 6E shows the displacement body 21, which corresponds to a vertical reflection of the displacement body 21 according to FIG. 6C. In all cases, the cone angle β of the surface is preferably in the range between 90° and 160°, more preferably between 120° and 152°.

FIGS. 6F and 6G show the displacement bodies according to FIGS. 6C and 6D in a vertical projection, in which the area of the apertures 25, 26 can be seen in relation to the total area of the displacement body 21. The displacement body 21 preferably has apertures 25, 26 for the flow of the granular material 4, and these, in such a vertical projection, account for between 10% and 60%, preferably between 30% and 50%, of the total area of the displacement body 21.

The forms of displacement bodies shown in FIG. 6A to 6G can each also be used as upper displacement body 27.

The person skilled in the art will be able to further optimize the shape of the displacement body in the course of tests. The focus here is in particular on restricting the particle flow of the moving bed to a minimum degree, permitting uniform flow of the gaseous feedstock stream through it, and ensuring maximum effectiveness of transmission of oscillation.

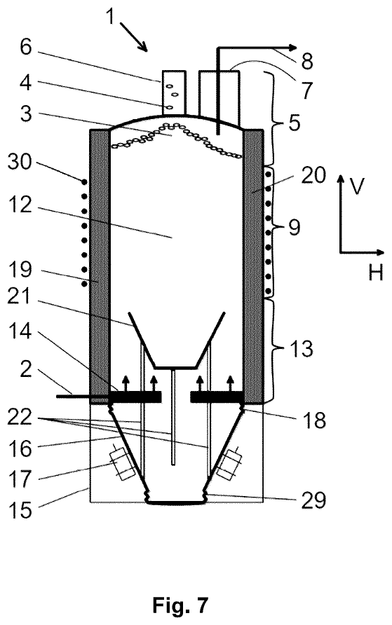

FIG. 7 shows a sixth working example of the invention, which differs from the third working example in that, rather than electrodes in the reactor 1, a coil 30 for inductive heating of the moving bed 3 is disposed on the outside of the middle reactor section 9. The coil 30 generates an alternating magnetic field in the reactor 1, which induces eddy currents in the conductive granular material 4. Because of the intrinsic electrical resistance of the moving bed 3, the ohmic losses of the eddy currents lead to heating of the moving bed 3. The sixth working example is notable for a particularly small number of components disposed in the interior of the reactor 1. In this way, it is possible to minimize carbon deposits in the reactor 1 and to achieve minimum disruption of flow of the moving bed 3.

Otherwise, the statements relating to the previous working examples are correspondingly applicable.

### LIST OF REFERENCE SIGNS

1 reactor
2 feedstock stream
3 moving bed
4 granular material
5 upper reactor section
6 feed for granular material
7 outlet for gas product stream
8 product stream
9 middle reactor section
10, 10′, 11, 11′ electrodes
12 reaction volume
13 lower reactor section
14 feeding device
15 outlet for granular material
16 oscillating base
17 first vibration generators
18 suspension
19, 20 side walls
21 lower displacement body
22 brace
23 extensions
24 cut-outs
25, 26 apertures in the displacement body
27 upper displacement body
28 second vibration generator
29 outlet sleeve
30 coil
H horizontal direction
H1 lower half of the preheating volume
H2 upper half of the preheating volume
V vertical direction
Vv preheating volume
β cone angle

1-15. (canceled)

16. A reactor for thermal decomposition of a gaseous hydrocarbonaceous feedstock stream in an electrically heated moving bed composed of an electrically conductive granular material with deposition of elemental carbon on the granular material, comprising:
an upper reactor section in which there are disposed a feed for the granular material and an outlet for a hydrogenous product stream;
a middle reactor section; and
a lower reactor section in which there is disposed a feeding device for the gaseous hydrocarbonaceous feedstock stream, and there is provided an outlet for the granular material on a bottom side;
wherein the outlet comprises at least one funnel-shaped oscillating base that can be set in oscillation in a vertical and/or horizontal direction by at least one first vibration generator and is connected to the lower reactor section via an oscillation-decoupling suspension.

17. The reactor of claim 16, wherein in the middle reactor section there are disposed at least two electrodes for heating the moving bed.

18. The reactor of claim 17, wherein the electrodes comprise an upper electrode and a lower electrode, each extending along a horizontal cross-sectional surface of the reactor.

19. The reactor of claim 17, wherein the electrodes are arranged on mutually opposite side walls of the reactor.

20. The reactor of claim 16, wherein at least one coil for inductive heating of the moving bed is disposed on the outside of the middle reactor section.

21. The reactor of claim 16, wherein in the lower reactor section there is disposed a lower displacement body which is secured by a brace to the oscillating base and can be set in oscillation together with the oscillating base.

22. The reactor of claim 21, wherein the lower displacement body is disposed above the feeding device.

23. The reactor of claim 21, wherein the lower displacement body is disposed entirely within a preheating volume of the reactor which is defined by the feeding device and the lowermost point of the electrodes.

24. The reactor of claim 21, wherein:
the electrodes comprise an upper electrode and a lower electrode, each extending along a horizontal cross-sectional surface of the reactor; and
the displacement body has extensions projecting into cut-outs in the lower electrode.

25. The reactor of claim 21, wherein:
the electrodes comprise an upper electrode and a lower electrode, each extending along a horizontal cross-sectional surface of the reactor; and
the displacement body forms the lower electrode.

26. The reactor of claim 21, wherein the displacement body has a conical or frustoconical surface.

27. The reactor of claim 26, wherein a cone angle of the surface is in the range between 90° and 160°.

28. The reactor of claim 26, wherein a cone angle of the surface is in the range between 120° and 152°.

29. The reactor of claim 21, wherein the displacement body has apertures for the flow of the granular material, and these, in a vertical projection, account for between 10% and 60% of a total area of the displacement body.

30. The reactor of claim 21, wherein the displacement body has apertures for the flow of the granular material, and these, in a vertical projection, account for between 30% and 50% of a total area of the displacement body.

31. The reactor of claim 16, wherein in the upper reactor section, there is disposed an upper displacement body which can be set in oscillation by at least one second vibration generator.

32. The reactor of claim 16, wherein the at least one vibration generator is set up to generate oscillations of the oscillating base with a frequency in the range from 25 Hz to 75 Hz and/or an oscillation speed in the range from 10 mm/s to 40 mm/s.
